(19) United States
(12) Patent Application Publication
(10) Pub. No.: US 2007/0263803 A1
(43) Pub. Date: Nov. 15, 2007

(54) COMMUNICATION DEVICE AND METHOD FOR FILTERING INCOMING CALLS THEREOF

(75) Inventor: Wu-Hsiung Chan, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/608,811

(22) Filed: Dec. 9, 2006

(30) Foreign Application Priority Data
Apr. 14, 2006 (TW) 095113414

(51) Int. Cl. H04M 11/00

(52) U.S. Cl. 379/93.02

(57) ABSTRACT

A communication device for filtering incoming calls includes a phone number database, a rule database, a filter module, and a rule operator module. The phone number database is used for storing a plurality of phone numbers. The rule database is used for storing a plurality of rules that include a plurality of common rules for dealing with incoming calls with phone numbers stored in the phone number database, and a plurality of particular rules for dealing with indefinite incoming calls. The filter module is connected to the phone number database and the rule database, for comparing the phone numbers of the incoming calls with those in the phone number database, and for retrieving rules from the rule database based on the comparison. The rule operator module is connected to the filter module, for dealing with the incoming calls according to the retrieved rules.

### BACKGROUND OF THE INVENTION

1. Field of the Invention

The invention relates to communication devices, and particularly to a communication device for filtering incoming calls.

2. Description of Related Art

With rapid development in electronic communication networks, phones have become more popular and important in people's daily life. However, phone subscribers may receive unwanted calls. For example, calls causing a display on the phone to indicate an unknown number, and some calls with phone numbers do not display on the phone, because some callers can hide the phone numbers, these calls may be from telephone solicitors or may even be of a criminal nature or intent, which will certainly bother the phone subscribers.

At present, the phones usually have incoming call display function and call memory function, and so on. However, these functions cannot effectively reduce the number of unwanted calls received.

### SUMMARY OF THE INVENTION

An exemplary embodiment of the invention provides a communication device for automatically filtering incoming calls. The communication device for filtering incoming calls includes a phone number database, a rule database, a filter module, and a rule operator module. The phone number database is used for storing a plurality of phone numbers. The rule database is used for storing a plurality of rules that include a plurality of common rules for dealing with incoming calls from phone numbers stored in the phone number database, and a plurality of particular rules for dealing with indefinite incoming calls. The filter module is connected to the phone number database and the rule database, for comparing the phone numbers of the incoming calls with that in the phone number database, and for retrieving rules from the rule database based on the comparison. The rule operator module is connected to the filter module, for dealing with the incoming calls according to the retrieved rules.

Another exemplary embodiment of the invention provides a method for filtering incoming calls. The method for filtering incoming calls includes: providing a rule database containing a plurality of common rules for dealing with incoming calls with phone numbers stored in a phone number database, and a plurality of particular rules for dealing with indefinite incoming calls; receiving an incoming call; determining whether the incoming call has a phone number; querying the rule database to retrieve a rule to deal with the incoming call if the incoming call does not have a phone number; and processing the incoming call according to the retrieved rule.

Other advantages and novel features will become more apparent from the following detailed description when taken in conjunction with the accompanying drawings, in which:

### BRIEF DESCRIPTION OF THE DRAWINGS

FIG. 1 shows a block diagram of a communication device in accordance with an exemplary embodiment of the invention;

FIG. 2 shows a flow chart of a method for filtering incoming calls in accordance with another exemplary embodiment of the invention; and

FIG. 3 shows a flow chart of a method for filtering incoming calls in accordance with a further exemplary embodiment of the invention.

### DETAILED DESCRIPTION OF THE INVENTION

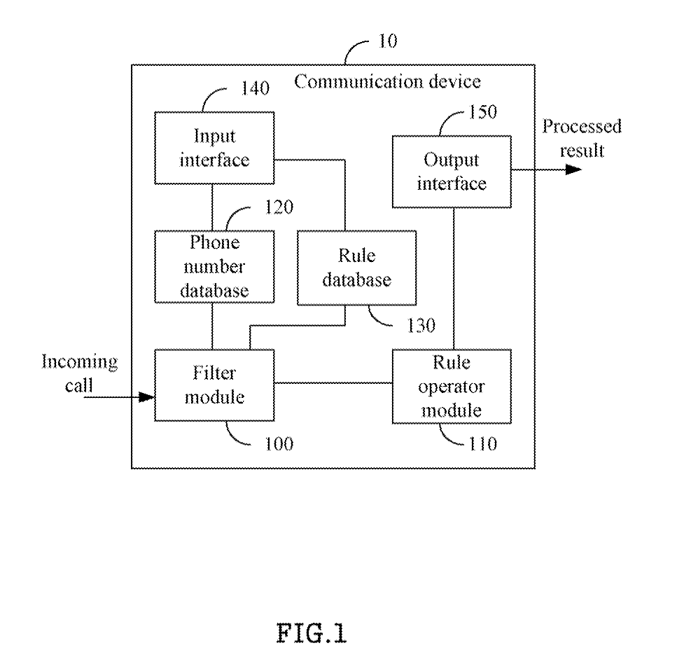

FIG. 1 shows a block diagram of a communication device 10 in accordance with an exemplary embodiment of the invention. In the exemplary embodiment, the communication device 10 processes different calls according to different rules for the purpose of filtering various incoming calls. The communication device 10 includes a filter module 100, a rule operator module 110, a phone number database 120, and a rule database 130. In some applications, the phone number database 120 and the rule database 130 may be located in a memory card for meeting mobile communication requirements.

In the exemplary embodiment, the phone number database 120 stores a plurality of phone numbers or calling numbers input by a user of the communication device 10. In alternative exemplary embodiments, the phone number database 120 further stores caller names corresponding to the plurality of phone numbers.

The rule database 130 stores a plurality of common rules and particular rules input by users. The common rules are corresponding to incoming calls from phone numbers stored in the phone number database 120. The particular rules are corresponding to indefinite incoming calls, such as incoming calls without phone numbers, or incoming calls with phone numbers not matching with that stored in the phone number database 120, because some callers can hide the phone number, and the phone number is not displayed on the phone.

Each of the rules includes an index code and a processing type, as shown in the following chart. In the exemplary embodiment, the processing type may be a Passing type, a Forwarding type, a Warning type, and a Rejecting type, respectively corresponding to index codes 0, 1, 2, and 3. In alternative exemplary embodiments, the processing type may be other kinds indicating processing means of incoming calls. In the exemplary embodiment, the phone number database 120 is further used for storing the index codes of the rules corresponding to the plurality of phone numbers.

| Index code | Processing type |
|---|---|
| 0 | Rejecting |
| 1 | Warning |
| 2 | Forwarding |
| 3 | Passing |

The above chart shows a mapping relation between the index numbers and the processing types. The mapping relation may be initially stored in the rule database 130. If the index code is 0, the corresponding processing type is Rejecting; if the index code is 1, the corresponding processing type is Warning; if the index code is 2, the corresponding type is Forwarding; if the index code is 3, the corresponding processing type is Passing. In another exemplary embodiment, there may be other mapping relations between the index codes and the processing types. In the exemplary embodiment, the particular rules corresponding to the index code of “0” are used to deal with the incoming calls without phone numbers, and the particular rules corresponding to the index code of “1” are used to deal with the incoming calls with phone numbers not matching with any of those stored in the phone number database 120.

The processing types further include sub-processing types. In this embodiment, if the processing type of an incoming call is Passing, the sub-processing type defines different passing objects, and the incoming call is answered by some designated recipients. For example, if a designated recipient is a father, it shows that the incoming call be answered by the father. If the processing type of an incoming call is Forwarding, the sub-processing type defines different forwarding numbers. For example, if the sub-processing type is 202-1234567, it shows that the incoming call be redirected or forwarded to the telephone number 202-1234567. In the exemplary embodiment, if the communication device 10 is used in a public switched telephone network (PSTN), the communication device 10 does not have the forwarding function; if the processing type is Warning or Rejecting, the sub-processing type is null.

In the exemplary embodiment, the filter module 100 is connected to the phone number database 120 and the rule database 130, and is used for comparing the phone number of the incoming call with that in the phone number database 120, and for retrieving rules from the rule database 130 based on the comparison. The filter module 100 is further used for determining whether the incoming call has a phone number or calling number, because some callers or calling sources can hide the phone number, and the phone number is not displayed on the phone. If the incoming call does not have a phone number, the filter module 100 requests a caller or calling source of the incoming call to input the phone number, and checks whether the phone number is received. If the incoming call has a phone number, the filter module 100 queries the phone number database 120 to determine whether the received phone number matches with one of the phone numbers stored in the phone number database 120. The rule operator module 110 is connected to the filter module 100, and is used for dealing with the incoming call according to the retrieved rule.

The communication device 10 further includes an input interface 140 and an output interface 150. The input interface 140 is connected to the phone number database 120 and the rule database 130, and is used for inputting phone numbers to the phone number database 120 and inputting rules to the rule database 130. The output interface 150 is connected to the rule operator module 110, and is used for outputting processed results of the rule operator module 110. In the exemplary embodiment, the output interface 150 may be a speaker module (not shown), a display module (not shown), or a combination thereof. For example, if the processing type of rule is “Warning”, the rule operator module 110 generates a warning signal, such as a warning ring signal and a warning picture, the output module 150 outputs the warning ring signal and the warning picture to the subscriber to notify that the incoming call is an unwanted incoming call.

In the exemplary embodiment, if the filter module 100 receives an incoming call, the filter module 100 determines whether the incoming call has a phone number, because some callers can hide the phone number, and the phone number is not displayed on the phone. If not, the filter module 100 requests the caller to input the phone number, and determines whether the phone number is received. In the exemplary embodiment, the filter module 100 requests the caller to input the phone number by voice. If the filter module 110 does not receive the input phone number, the filter module 110 queries the rule database 130 to retrieve the particular rule, and the rule operator module 110 deals with the incoming call according to the particular rule. In the exemplary embodiment, the index code “0” represents the particular rules for dealing with incoming calls without phone numbers, and the corresponding processing type is rejecting. In the exemplary embodiment, the filter module 100 stores the index codes of the particular rules corresponding to the incoming calls without phones numbers, and queries the rule database 130 according to the index codes.

If the filter module 100 receives the phone number, the filter module 100 queries the phone number database 120 to determine whether the phone number is stored in the phone number database 120. If not, the filter module 100 queries the rule database 130 to retrieve a corresponding particular rule. In the exemplary embodiment, the particular rule corresponding to the incoming call with phone number not matching with one of those stored in the phone number database 120 is represented by the index code “1,” and the corresponding processing type is Warning. That is the rule operator module 110 generates a warning signal. In the exemplary embodiment, the filter module 100 stores the index codes of the particular rules corresponding to the incoming calls, and queries the rule database 130 according to the index codes.

If the phone number of the incoming call is stored in the phone number database 120, the filter module 100 retrieves an index code corresponding to the phone number, and queries the rule database 130 to retrieve a corresponding rule according to the index code corresponding to the phone number. In the exemplary embodiment, the index code corresponding to the incoming call with phone number matching with one of those stored in the phone number database 120 is 2 or 3, the processing type corresponding to the index code “2” is Forwarding, and the processing type corresponding to the index code “3” is Passing. If the processing type is Passing, the rule operator module 110 defines a Passing incoming call according to the sub-processing type, and the incoming call defined by the sub-processing type is displayed as defined by the output interface 150.

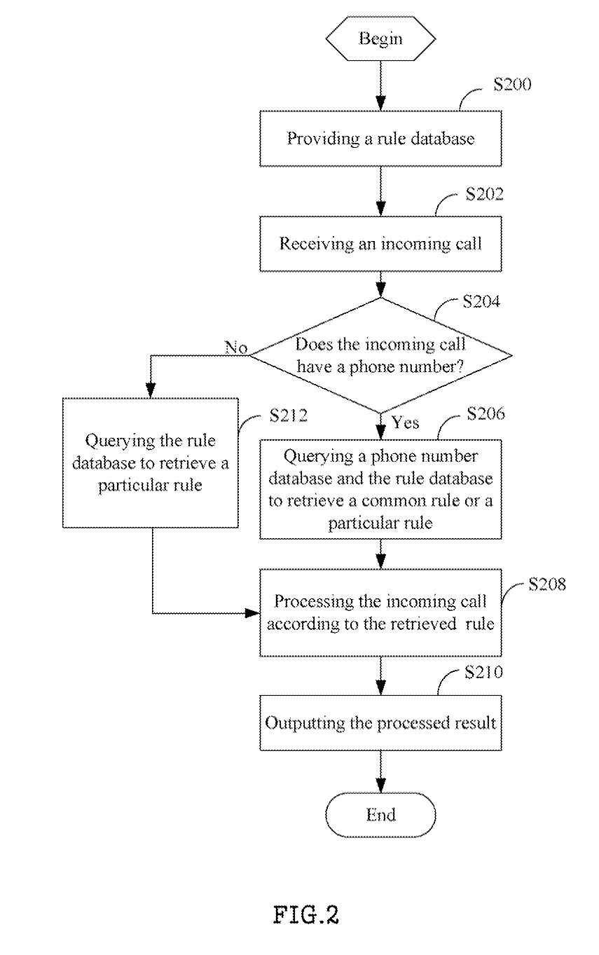

FIG. 2 shows a flow chart of a method for filtering incoming calls in accordance with an exemplary embodiment of the invention. In step S200, the communication device 10 provides a rule database, in the exemplary embodiment, the rule database includes a plurality of common rules for dealing with incoming calls with a phone number matching with one of those stored in a phone number database, and a plurality of particular rules for dealing with indefinite incoming calls, the indefinite incoming calls include incoming calls without phone numbers, and incoming calls with phone numbers not matching with one of those stored in the phone number database. In step S202, the filter module 100 of the communication device 10 receives an incoming call. In step S204, the filter module 100 determines whether the incoming call has a phone number, because some callers can hide the phone number, and the phone number is not displayed on the phone. If the incoming call has a phone number, in step S206, the filter module 100 queries the phone number database 120 and the rule database 130 to retrieve a corresponding common rule or a corresponding particular rule. In step S208, the rule operator module 110 processes the incoming call according to the retrieved rule. In step S210, the output interface 150 outputs the processed result of the rule operator module 110.

If the filter module 100 determines the incoming call does not have a phone number, in step S212, the filter module 100 queries the rule database 130 to retrieve a particular rule corresponding to the incoming call without phone number. Then the process goes to step S206.

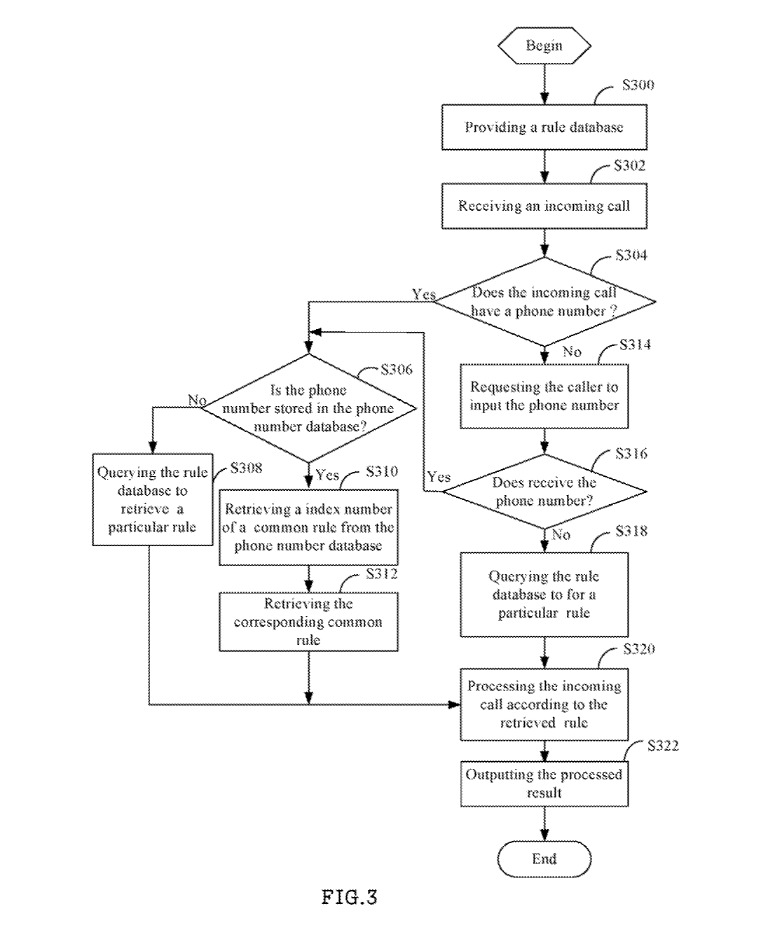

FIG. 3 shows a flow chart of a method for filtering incoming calls in accordance with another exemplary embodiment of the invention. In step S300, the communication device 10 provides a rule database, in the exemplary embodiment, the rule database includes a plurality of common rules for dealing with incoming calls with phone numbers stored in a phone number database, and a plurality of particular rules for dealing with indefinite incoming calls, the indefinite incoming calls include incoming calls without phone numbers, and incoming calls with phone numbers not matching with any of those stored in the phone number database, because some callers can hide the phone number, and the phone number is not displayed on the phone. In step S302, the filter module 100 receives an incoming call. In step S304, the filter module 100 determines whether the incoming call has a phone number. If the incoming call has a phone number, in step S306, the filter module 100 queries the phone number database 120 to determine whether the phone number matches with one of those stored in the phone number database 120. If the phone number does not match with one of those stored in the phone number database 120, in step S308, the filter module 100 queries the rule database 130 to retrieve a particular rule corresponding to the incoming call with a phone number not matching with one of those stored in the phone number database 120.

In step S320, the rule operator module 110 processes the incoming call according to the retrieved rule. In step S322, the output interface 150 outputs the processed result of the rule operator module 110. In the exemplary embodiment, the processing type of the particular rule corresponding to the incoming call from a phone number not matching with one of those stored in the phone number database 120 is Warning, the rule operator module 110 generates a warning signal, such as a warning ring signal and a warning picture, the output interface 150 outputs the warning ring signal and the warning picture to notify the subscriber.

If the phone number is stored in the phone number database 120, in step S310, the filter module 100 retrieves an index code of the common rule corresponding to the phone number from the phone number database 120. In step S312, the filter module 100 queries the rule database 130 according to the retrieved index code, and retrieves a common rule corresponding to the phone number, then the process turns to step S320.

If the filter module 100 determines the incoming call does not have a phone number, in step S314, the filter module 100 requests the caller to input the phone number. In step S316, the filter module 100 determines whether a phone number is received. If a phone number is received, then the process turns to step S306. If not, then in step S318, the filter module 100 queries the rule database 130 to retrieve a particular rule corresponding to the incoming call without phone number, and then the process turns to step S320.

The communication device 10 can deal with different incoming calls according to different rules, especially rejecting unwanted incoming calls or notifying subscribers that incoming calls are of unknown type and may be unwanted according to the particular rule, in this way the communication device 10 reduces interruptions from unwanted incoming calls.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A communication device for filtering incoming calls, comprising:
a phone number database for storing a plurality of phone numbers;
a rule database for storing a plurality of rules that comprise a plurality of common rules for dealing with incoming calls with phone numbers stored in the phone number database, and a plurality of particular rules for dealing with indefinite incoming calls; a filter module connected to the phone number database and the rule database, for comparing the phone numbers of the incoming calls with that in the phone number database, and for retrieving rules from the rule database based on the comparison; and
a rule operator module connected to the filter module, for dealing with the incoming calls according to the retrieved rules.

2. The communication device of claim 1, wherein the indefinite incoming calls comprise the incoming calls without phone numbers, and the incoming calls with phone numbers not matching with one of those stored in the phone number database.

3. The communication device of claim 1, wherein the filter module is further used for determining whether an incoming call has a phone number.

4. The communication device of claim 3, wherein the filter module is further used for sending a request to a caller, requesting the caller to input a phone number, and querying whether the phone number is received from the caller.

5. The communication device of claim 3, wherein the filter module is further used for querying the phone number database to determine whether the phone number of the incoming call is stored in the phone number database.

6. The communication device of claim 1, wherein each of the rules comprises an index code and a processing type; the rule database further comprises a mapping relation between the index codes and the processing types, and wherein the processing types comprise a Passing type, a Forwarding type, a Warning type, and a Rejecting type.

7. The communication device of claim 6, wherein the phone number database is further used for storing the index codes of the common rules corresponding to the phone numbers stored in the phone number database.

8. The communication device of claim 1, wherein the processing type of the particular rules corresponding to incoming calls without phone number is Rejecting.

9. The communication device of claim 1, wherein the processing type of the particular rules corresponding to incoming calls with phone numbers not matching with one of those stored in the phone number database is Warning.

10. The communication device of claim 1, further comprising an input interface, connected to the phone number database and the rule database, for inputting the phone number to the phone number database and inputting the rules to the rule database.

11. The communication device of claim 1, further comprising an output interface, connected to the rule operator module, for outputting the processed result of the rule operator module.

12. The communication device of claim 1, wherein the phone number database and the rule database are located in a memory card for meeting mobile communication requirements.

13. A method for filtering incoming calls, comprising:
providing a rule database comprising a plurality of common rules for dealing with incoming calls with phone numbers stored in a phone number database, and a plurality of particular rules for dealing with indefinite incoming calls;
receiving an incoming call;
determining whether the incoming call has a phone number;
querying the rule database to retrieve a rule to deal with the incoming call if the incoming call does not have a phone number; and
processing the incoming call without a phone number according to the retrieved rule.

14. The method for filtering incoming calls of claim 13, wherein the indefinite incoming calls comprise the incoming calls without phone numbers, and the incoming calls with phone numbers not matching with one of those stored in the phone number database.

15. The method for filtering incoming calls of claim 13, further comprising the steps of:
sending a request to a caller for a phone number if the incoming call does not have a phone number; and
determining whether a phone number is received from the caller.

16. The method for filtering incoming calls of claim 15, further comprising:
querying the rule database to retrieve a particular rule corresponding to the incoming call without a phone number if no phone number is received from the caller.

17. The method for filtering incoming calls of claim 15, further comprising:
determining whether the phone number is stored in the phone number database if the phone number is received;
retrieving an index code of a rule corresponding to the phone number from the rule database if the phone number is stored in the phone number database; and
querying the rule database to retrieve a common rule corresponding to the phone number stored in the phone number database according to the index code.

18. The method for filtering incoming calls of claim 17, further comprising:
querying the rule database to retrieve a particular rule if the phone number of the incoming call is not stored in the phone number database.

19. A method for filtering incoming calls of a communication device, comprising:
predefining a rule database comprising a plurality of rules for dealing with incoming calls of a communication device in ways different from each other;
receiving an incoming call;
querying said rule database to retrieve a rule out of said plurality of rules to deal with said incoming call based on information of said incoming call; and
processing said incoming call according to said retrieved rule.

20. The method of claim 19, further comprising a step of verifying said incoming call to retrieve said information of said incoming call by means of determining whether a calling number of a calling source of said incoming call is available.
